(19) United States
(12) Patent Application Publication
(10) Pub. No.: US 2005/0035473 A1
(43) Pub. Date: Feb. 17, 2005

(54) Device for material and/or energy exchange in a wash column

(76) Inventor: Rolf P.C. Manteufel, Bad Harzburg (DE)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/871,122

(22) Filed: Jun. 18, 2004

Related U.S. Application Data
(63) Continuation of application No. PCT/EP02/14612, filed on Dec. 20, 2002.

(30) Foreign Application Priority Data
Dec. 20, 2001 (EP) 01130406.0

(51) Int. Cl. B01F 3/04

(52) U.S. Cl. 261/97

(57) ABSTRACT

A device for maximum vapor or gas throughput is provided for material and/or energy exchange, in which large vertical flow spaces are present. Vapors or gases flow without impact losses and thus with extremely low pressure loss per meter in counter flow to liquid on zigzag wires or threads arranged vertically next to one another, produced with conventional web or braiding machines, along wide-meshed fabric or grid webs and are brought for exchange with the liquid. Simultaneously, by optimizing the wire or thread diameter and its count and the arrangement of fabric or grid webs, considering the large vertical flow spaces and a uniform wetting of the large number of zigzag wires or threads arranged vertically next to one another against the wave peaks, a minimal specific volume of the device is achieved by wide-meshed fabrics or grids for the vapor or gas flow through a step-wise division of the trickling liquid.

### CROSS-REFERENCE TO RELATED APPLICATIONS

This application is a continuation of International Application No. PCT/EP02/14612, filed Dec. 20, 2002, and the disclosure of which is incorporated herein by reference.

### BACKGROUND OF THE INVENTION

The invention relates to a device for the exchange of material and/or energy in a wash column, wherein three-dimensional wire or thread packing in a form of at least one group of wide-meshed fabrics or grids is arranged in parallel in the column.

For optimum benefit in using such a device, the phases to be exchanged must be fed in counter flow with the largest possible phase contact or boundary surface and the smallest possible energy loss (≢p/m). A large phase boundary surface can be achieved by providing a large number of wires or threads guided vertically through the device, wherein the liquid running down these wires or threads is constantly replaced and is located in direct counter flow to the rising phase.

Here, the uniform flow of the liquid requires a similarly uniform feeding at the head of all wires or threads. Any amount of shift means poor distribution, wherein a deviation of ±50% among the individual trickling amounts leads to a doubling of the necessary exchange surface, and with larger deviations the exchange surface has practically no more effect on the separating performance.

In addition to the uniform trickling amounts of the liquid, vertical flow chambers for the rising second phase must be available, in order to achieve maximum rates without impact losses leading to accumulation of the running liquid layers.

For improving the device according to International patent application PCT/EP00/07756 and its corresponding publication WO 01/87448 A1, it has been shown that the spatial construction described there for the wire or thread packing can also be composed of wide-meshed fabrics or welded grids. In addition, mesh widths of a certain dimension can be formed, which can be manufactured on conventional web or braiding machines, when certain measures are taken into account in the formation and in the arrangement.

### BRIEF SUMMARY OF THE INVENTION

According to the invention; the fabric or grid webs lie in contact with each other. Wide-meshed fabrics are used, which, relative to the installation state in the column, have vertically running, zigzag wires or threads, or groups of wires or threads, which are spaced apart from each other, preferably at approximately 3-20 mm, to form a mesh.

The wires and threads, both in the warp direction and also in the weft direction, can be formed as monofilaments or also multifilaments. For reasons of simplicity, the following description speaks only of wires.

The mentioned vertical wires are usually the warp wires. In a preferred embodiment of the fabrics used, the warp wires do not run in a straight line, but instead they are zigzag, wavy, or otherwise curvilinear in planes perpendicular to the fabric surface. In contrast, for such a preferred embodiment, the horizontal wires, usually the weft wires, run in a straight line or also zigzag. This leads to the result that the warp wires travel relatively far, because they are led back and forth around the weft wires, so that the thickness of fabric with warp and weft wires of the same thickness is three-times the wire thickness, namely twice the thickness of the warp wires and one time the thickness of the weft wire. However, the invention is not limited to this special embodiment of the fabric or grid.

For the previously described formation, the warp wires bulge outwardly alternately on one and then the other side of the fabric. According to the invention, two or more fabric webs are now brought into contact with each other, so that the facing bulges of the warp wires contact adjacent fabric or grid webs. Therefore, the center planes of the fabric webs, especially their weft wires, are held at a distance from each other. The previously mentioned contact can be achieved such that fabric or grid webs are brought into contact in a mirror image arrangement or are arranged with a mesh width offset relative to the adjacent fabric or grid web. It is not necessary for all warp wire bulges of the webs to contact each other. It is sufficient if there are significant percentage of such points.

The stability of the contact points is better enabled in a special embodiment, in that two or more vertical, wavy wires are arranged one directly next to the other. Then, the warp wire of an adjacent fabric or grid web can come to lie with its bulge between the bulges of the double wire of the adjacent fabric or grid web, which creates a stable position. With individual wires the position can be unstable, when the bulges lying against to each other tend to slide off their opposing peak points. Another possibility for increasing the stability is the arrangement of fabric or grid webs with warp wires lying one directly next to the other alternating with webs in which the warp wires are present individually. In this way, the individual warp wires each come to lie between the bulges of the warp wires lying directly next to each other in adjacent webs, whereby a stable position is likewise achieved.

The adjacent fabric or grid webs are expediently fixed in their contact position. This can be achieved by various means. For example, the webs are tied to each other at a plurality of points, e.g., by threads. However, depending on the material, point-like welds or clips can also be provided. In this way, packets of two or more webs can be generated. With the warp wires, which always contact each other in the vertical profile and which are arranged in the mesh spacing of the web, practically continuous vertical flow channels are formed between adjacent longitudinal wires, which represent a path for the rising reaction phase.

Now it is not necessary for a weft wire to be located behind each bulge of a warp wire. In particular, with stiff wire material, the warp wires can be wavy and can be connected by a weft wire only at a spacing of several waves. In a preferred embodiment, the weft wires of adjacent webs, provided only at a large spacing from each other, are arranged such that they are offset relative to each other in the vertical direction. With such a loose arrangement cross flow of the rising medium through the webs is also supported. The cross section of the formed vertical flow channels depends on one hand on the mesh width, on the vertical spacing of the warp wires from each other, and on the other hand on the wire thickness. This preferably lies in a range of about 0.5 to 3 mm.

Alternatively, the liquid distribution can also be realized, in that the upper wires of the fabric or grid webs are assembled into certain groups in tubes or sleeves and connect directly with the discharge openings or are fed by wires hanging into these openings.

The wires in the tubes or sleeves can also be assembled into individual bundles, e.g., of 4 or 6 wires, and be arranged next to one another in the tubes or sleeves.

For uniform liquid guidance, the bundles can also be guided, according to German published patent application DE 100 51 523 A1, by perforated bodies aligned with the bundles and supported with a centrally arranged rod.

Instead of the supply of liquid through supply tubes, this can also be realized by inlet channels located above the discharge channels.

The remaining vertical flow spaces are the determining factor for the number of wires and their dimensions and spacings relative to each other with a wire surface that is as large as possible. In this way, an optimum is found between the number of wires or threads and their dimension and arrangement in the device for realizing a low pressure loss (Δp/m) for the rising, lighter phase. The exchange surface itself is given by the wetted periphery of the wires and thus grows with its diameter and its number. On the other hand, their arrangement determines the free flow spaces, wherein with the number of wires and especially with their diameter, the free flow spaces become smaller and the material requirements increase.

In order to be able to mount the packing also through manholes, the fabric webs produced typically with an approximately 2-3 m width are divided into strips of preferably about 200-300 mm width and joined next to one another into packings of the desired length.

The determining factor for the uniform wetting of all wires is to divide the liquid to be distributed in the device such that each wire is supplied with liquid uniformly. This can be realized advantageously only step-by-step according to the amounts of liquid to be distributed individually.

Due to the relatively small amounts of liquid per wire, a special liquid distribution is necessary. Thus, the individual webs are suspended with their upper wire ends on distribution channels. Advantageously, the channels are divided into sections such that supply tubes can reliably provide the channel sections of a packing block.

The supply tubes of a packing block are assembled into a distributor head, which is supplied by a distributor feed system at a higher level according to the size of the device.

In the discharge channels, horizontal perforated sheets with laterally running slots or fabric are attached, which supply the liquid flowing through the supply tubes to the individual wires of the webs from below. In this way, a uniform liquid distribution is assured. The perforated sheets can serve simultaneously for clamping the wires suspended in the discharge channels.

Both the discharge openings of the distributor head and also the distributor feed system are calibrated, and each discharge opening is supplied from below, in that a supply channel through a perforated grid or tube is formed around each opening.

The lower wire ends of the webs are guided into open channels, which collect the running off liquid and which lead off into further discharge channels or an annular channel.

For extraction or other processes, in which a liquid phase is to be fed from below upwardly through the device, the described distributor device is attached analogously in an inverted arrangement at the lower end of the device.

The wires or threads of the packing may be electrically conductive, heat conductive and/or catalytically active. The wires or threads of the packing may be made of metallic or non-metallic material, especially plastic, glass fibers, carbon fibers, and mixtures thereof. The wires or threads may be formed as monofilaments, multifilaments, spun fibers, spun filaments, bored or expansion molded, and structures taking mesh warps into account.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a front elevation view of an installation of the complete device according to the invention in a cylindrical container;

FIG. 2a is a top view of a distributor head according to the invention;

FIG. 2b is a cross sectional end view of the distributor head of FIG. 2a;

FIG. 3 is detailed front elevation view, partially in section, of a portion of the device of FIG. 1, showing the suspension of the webs in the distributor channel;

FIG. 4 is a side view of a distributor channel, partially in section, with fabric web and distributor head;

FIG. 5 is a top view of a distributor head connected to a packing blocks of the invention;

FIG. 6 is a top view of an arrangement of a distributor channel connected to several blocks in a large cylindrical container;

FIG. 7a is a sectional elevation view showing wires in the tubes or sleeves of a discharge channel;

FIG. 7b is a side elevation view showing discharge channels of a packing block arranged next to one another; and

FIG. 7c is a side elevation view showing an arrangement of discharge channels in two planes for achieving densely lying liquid supply ports at the upper wire ends of a packing block

### DETAILED DESCRIPTION OF THE INVENTION

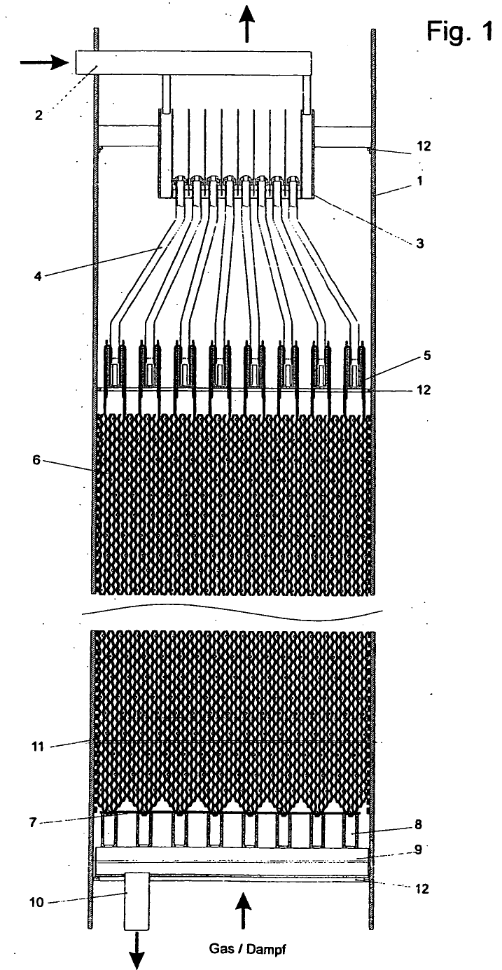

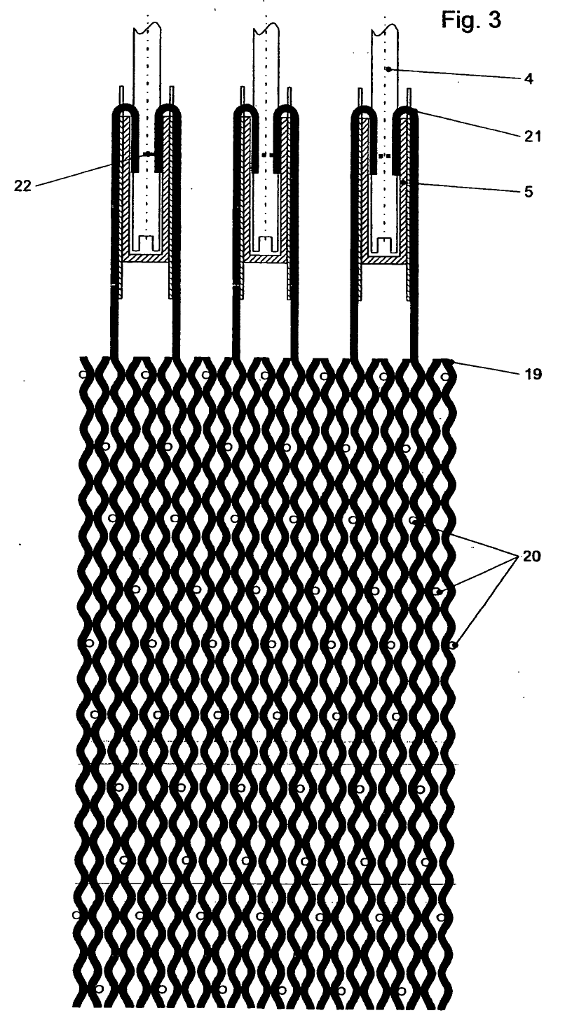

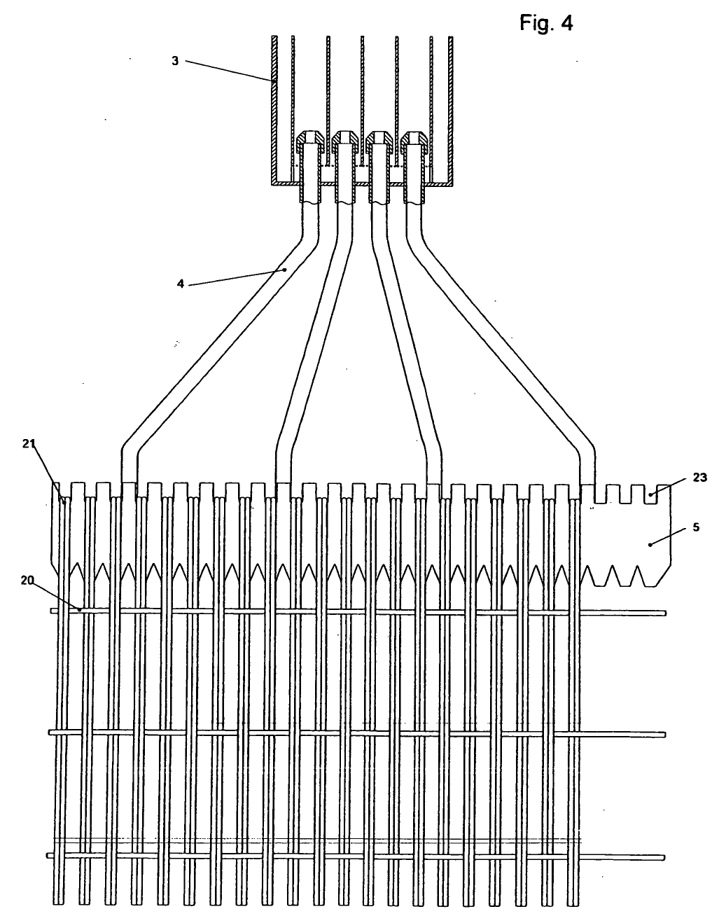

As an example, FIG. 1 shows the installation of the device in a cylindrical container 1 (column). The liquid enters through a supply tube 2 into the device and is fed through tubes into the distributor head 3. This distributes the liquid through the system shown in FIG. 3 uniformly to the supply tubes 4, which end in the distributor channels 5. Suspended on these channels is a packet made from fabric webs 6 arranged next to one another. The liquid is output from the channels 5 uniformly onto the fabric webs and guided downwardly on these webs.

The individual fabric webs are arranged next to one another, such that they are in contact at the wave peaks of the vertical wires and thus the liquid can transfer from web to web. The length of the webs can be adapted for the respective application purpose. At the lower end the block composed of fabric webs stands on a holder profile 7, which is fixed on several horizontally running discharge channels 8. The liquid trickling down on the vertical wires is collected in these channels and discharged into larger channels 9 lying underneath. From there, the liquid leaves the device, e.g., through a tube 10.

During operation of the device, a gas or vapor flows through the device from below in counter flow to the liquid. On the wall of the cylindrical container 1 a fine-meshed wire fabric 11 is applied, which lies with its full surface against the container wall. The distributor head 3, the distributor channels 5, and also the discharge channels 8 are fixed to holders 12. According to the application, several of these devices can be installed one above the other, in order to enable a partial outlet or an expanding supply of liquid between the individual devices.

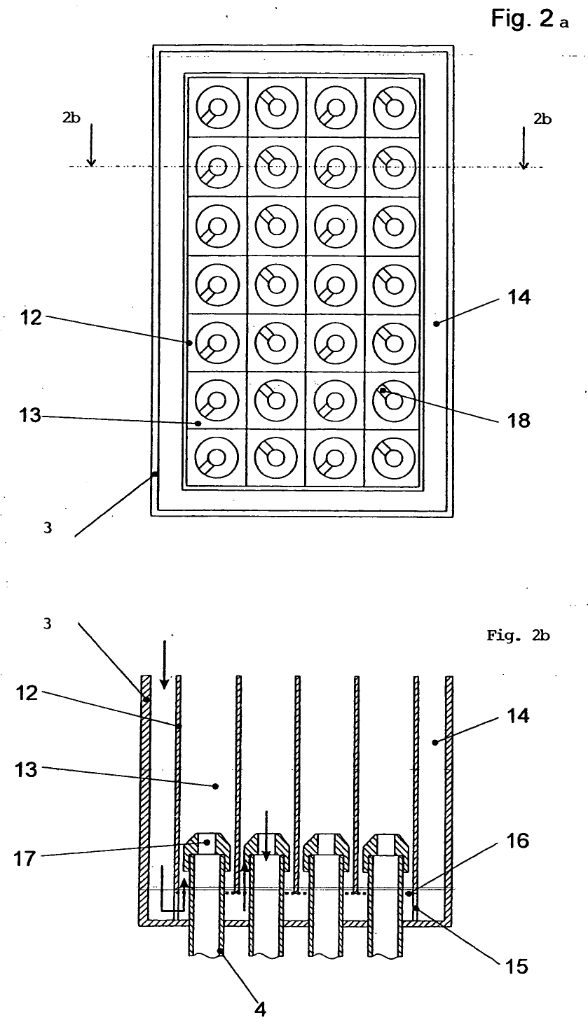

FIG. 2 shows the distributor head 3 from above and in a section diagram. The head is divided by sheets 12 into individual chambers 13. The liquid flows into the outer space 14 of the distributor head and distributes itself through cut outs 15 on the lower end of the sheet over the bottom surface of the head. Through a perforated sheet or fabric 16, the liquid rises into the chambers 13 and is distributed through calibrated discharge openings 17 to the individual supply tubes 4. Each of the calibrated discharge openings has a lateral channel 18, which improves the flow behavior for small volume flows. For each supply tube 4, a chamber 13 with calibrated discharge opening 17 is provided.

FIG. 3 shows the suspension of the fabric webs in the distributor channels, wherein the ends can also be inserted into the bases of the distributor channels. The individual fabric webs are arranged next to one another, such that adjacent webs contact each other with the wavy vertical wires 19 and the cross wires of the individual webs 20 run in different planes, which increases the free cross section for the vapor or the gas.

Several of the fabric webs are longer. The vertical wires 21 of these webs are guided upwardly out of the arrangement. These wires are bent at the ends and suspended in the associated distributor channel 5 and can be fixed by clamps with a perforated sheet or fabric strip 22. The perforated sheet or fabric strip separates the distributor channel horizontally into two chambers. The liquid enters through the supply tube 4 into the lower chamber. Due to the pressure loss of the perforated sheet or the fabric strip, the liquid is distributed into the lower chamber via the channel and flows uniformly into the upper chamber. When a certain damming height is reached in the distributor channel, the liquid trickles down on the suspended wires. At the contact points of the individually zigzag fabric webs, the liquid divides itself and thus uniformly distributes over the longitudinal wires of the packing block hanging next to one another.

FIG. 4 shows a distributor channel in a side view with a section through the associated chambers of the distributor head and a suspended wide-meshed fabric web. On the right side, a part of the vertical wires 21 is not shown, in order to better show the appearance of the distributor channel 5. The channel has on the top side rectangular slots 23, in which the wires 21 are suspended. The bottom side runs to the middle of each wire pair and thus prevents the dripping of the liquid between the suspended wires 21. The channel is divided on the inside into several sections, each section being fed by a supply tube 4. Alternatively, the wire ends can also be suspended in the base of the distributor channels.

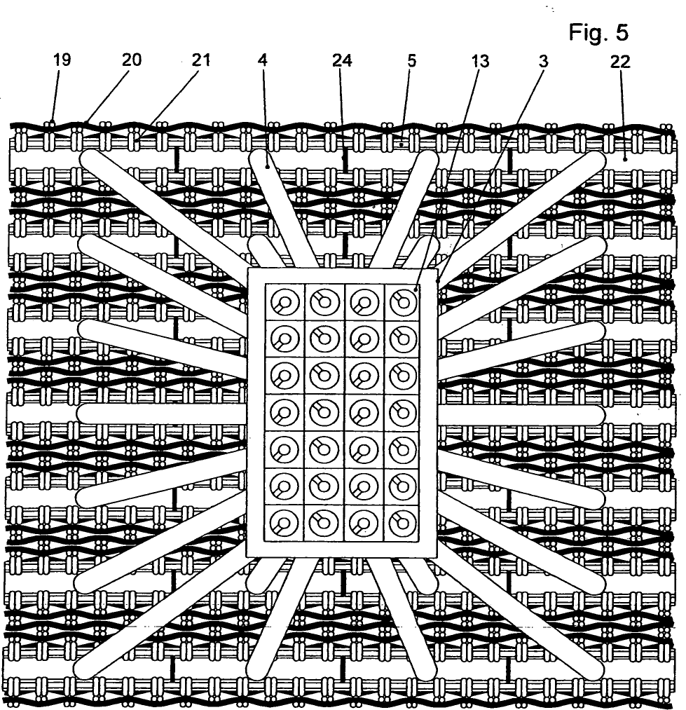

FIG. 5 shows a rectangular packing block with associated distributor head 13 from above. The horizontal cross wires 20 of the individual fabric webs are drawn in black and the vertically running wires 19 are drawn as white circles. One part of the fabric webs is suspended with its bent wire ends 21 in the distributor channels 5, as described above, or inserted into the base and can be fixed with the perforated sheet or fabric strip 22. Separating walls 24 divide the distributor channels into individual segments, each of which is supplied with liquid by a separate supply tube 4. A chamber 13 in the distributor head 3 is allocated to each supply tube and thus to each segment of the distributor channel.

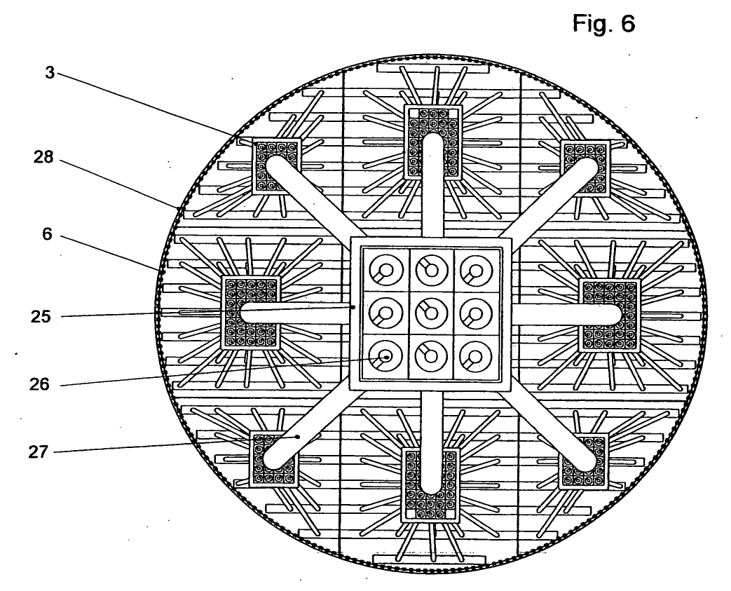

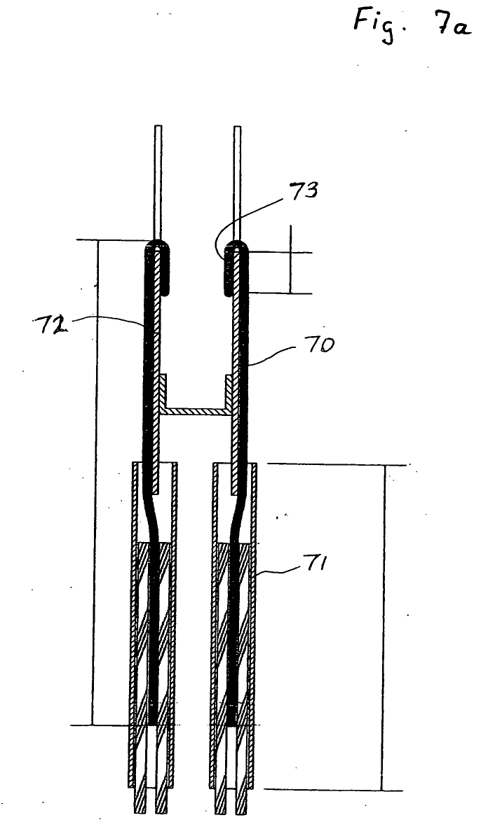

To equip cylindrical containers of large diameter with the described device, several of the blocks shown in FIG. 5 are installed next to one another. FIG. 6 shows one such arrangement for nine individual blocks. Each of the blocks has a separate distributor head 3. The supply of these distributor heads is realized in the way described above by a higher-level distributor head 25 by means of correspondingly larger calibrated discharge openings 26 and supply tubes 27.

As also shown in FIG. 1 for a small container diameter, a fine-meshed wire fabric 6, which distributes the liquid running off on the container wall, is installed with its full surface on the container wall 28.

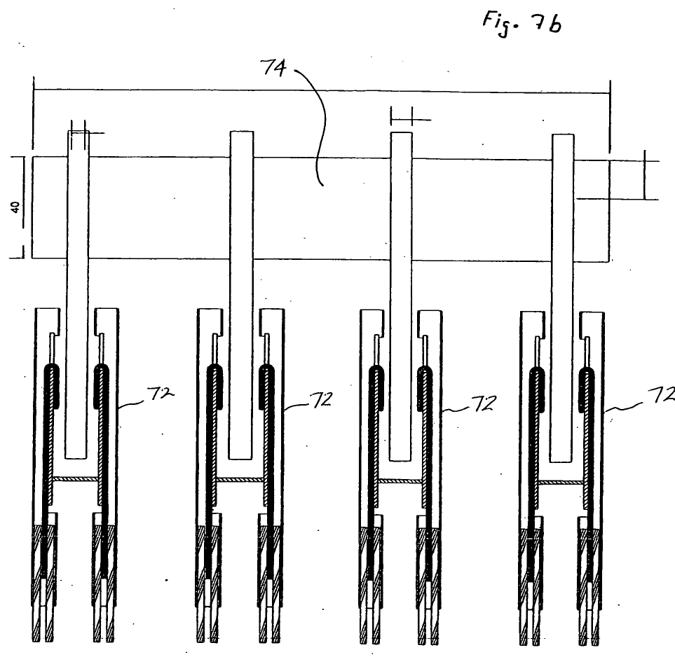

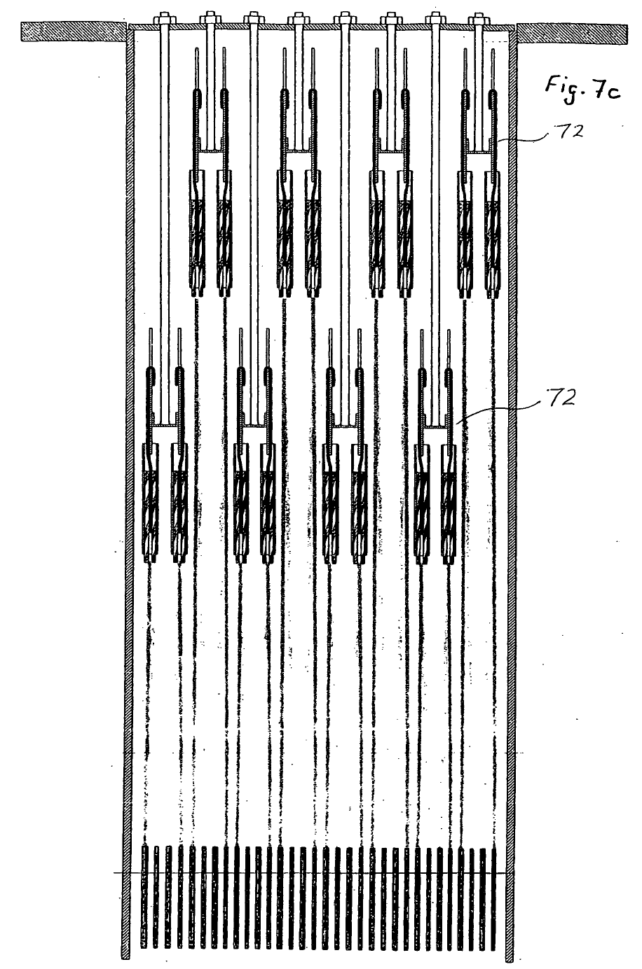

FIG. 7a shows the upper wires 70 in the tubes or sleeves 71 of a distribution channel 72, which are fed by the wires 73 hanging into the discharge openings.

FIG. 7b shows the distribution channels 72 of a packing block arranged next to one another, which are supplied in common by a supply channel 74.

FIG. 7c shows the possibility of arranging distribution channels 72 in two levels for achieving densely lying liquid supply ports at the upper wire ends of a packing block.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A device for material and/or energy exchange in a wash column, comprising three-dimensional wire or thread packing in a form of at least one group of wide-meshed fabric or grid webs (6) arranged in parallel in the column (1), wherein the webs (6) contain zigzag wires or threads (19) running vertically in the column and spaced apart from each other, the webs (6) being arranged such that adjacent webs contact each other at wave peaks of the zigzag wires or threads (19) and form substantially continuous vertical flow channels due to a mesh width of the wires or threads (19) at the spacing from each other.

2. The device according to claim 1, wherein individual webs (6) hang with their upper wire or thread ends (21) in distributor channels (5).

3. The device according to claim 2, wherein individual webs (6) hang with their upper wire or thread ends (21) assembled into tubes or sleeves located in the distributor channels (5).

4. The device according to claim 1, wherein the vertical wires or threads (19) have thicknesses of less than about 3 mm.

5. The device according to claim 1, wherein the spacing between vertical wires or threads (19) in the webs is about 3-20 mm.

6. The device according to claim 1, wherein the webs (6) contacting each other are divided into defined packing blocks with associated distributor channels (5).

7. The device according to claim 6, wherein each packing block has a distributor head (3) for liquid, the distributor head (3) feeding distributor channels (5) associated therewith.

8. The device according to claim 6, wherein horizontal boundary surfaces (16) are arranged in the distributor channels (5) for the liquid.

9. The device according to claim 7, wherein the distributor heads (3) of each packing blocks are fed by higher-level distributor heads.

10. The device according to claim 7, wherein of the distributor heads (3) have discharge openings (17) separated from each other by separating sheets (12) or tube pieces and the discharge openings (17) are fed from below.

11. The device according to claim 1, wherein the webs (6) are guided into open channels (9).

12. The device according to claim 11, wherein the open channels (9) are connected to discharge channels located under them.

13. The device according to claim 11, wherein the open channels (9) are guided into an annular channel.

14. The device according to claim 1, wherein a fabric surface is applied to an inner wall of the device.

15. The device according to claim 1, wherein a fabric surface is applied around the packing.

16. The device according to claim 1, wherein the wires or threads (19) of the packing have at least one of the properties of electrically conductivity, heat conductivity and catalytic activity.

17. The device according to claim 1, wherein the wires or threads (19) of the packing comprise a metallic or non-metallic material.

18. The device according to claim 1, wherein the non-metallic material is selected from the group consisting of plastic, glass fibers, carbon fibers, and mixtures thereof.

19. The device according to claim 1, wherein the wires or threads (19) have a form selected from the group consisting of monofilaments, multifilaments, spun fibers, spun filaments, bored or expansion molded, and structures taking mesh warps into account.
